(19) United States
(12) Patent Application Publication
(10) Pub. No.: US 2008/0048980 A1
(43) Pub. Date: Feb. 28, 2008

(54) Detecting movement of a computer device to effect movement of selected display objects

(75) Inventors: Robert Love, Cambridge, MA (US); Nathaniel Dourif Friedman, Munich (DE); David Reveman, Boston, MA (US)

Correspondence Address: PILLSBURY WINTHROP SHAW PITTMAN, LLP, P.O. BOX 10500, MCLEAN, VA, 22102, US

(73) Assignee: Novell, Inc., Provo, UT (US)

(21) Appl. No.: 11/707,894

(22) Filed: Feb. 20, 2007

Related U.S. Application Data
(60) Provisional application No. 60/823,219, filed on Aug. 22, 2006.

(51) Int. Cl. G06F 3/033

(52) U.S. Cl. 345/158

(57) ABSTRACT

The systems and methods of the invention relate to providing a computer device, having a display unit, with an accelerometer (or other motion sensor) to detect movement of the computer device (and/or an associated display unit) and generate movement data. An accelerometer driver may receive the generated movement data. The generated movement data may be processed and/or interpreted in order to create one or more control signals. The control signals may be sent to a display driver to control movement of one or more selected display objects on one or more display units. The control signals may control movement of selected display objects on a screen display (or between multiple screen displays) associated with the computer device.

This application claims the benefit of U.S. Provisional Application No. 60/823,219, filed Aug. 22, 2006, which is herein incorporated by reference in its entirety.

### BACKGROUND

1. Field of Invention

The invention relates to systems and methods for detecting movement of a computer device and using detected movements to generate movement data and/or control signals to control movement of selected display objects on a screen display or between multiple screen displays associated with the computer device.

2. Background of the Invention

Accelerometers and motion sensors in general are known and are used in various applications. Some computer devices include accelerometers. However, known uses typically relate to security (e.g., detecting unauthorized attempts to move a computer and sounding an alarm in the event unauthorized movement occurs) or hard disk protection when a device is dropped or subject to significant vibration (e.g., locking the hard drive or moving the read/write head away from the platters in the hard drive when the device detects rapid movement of the computer device).

Recently certain types of computers have used accelerometers for other limited applications. For example, some Tablet PCs have an accelerometer that can be used to detect rotation of a display and change the entire display screen orientation in response thereto. Typically, a limited amount of information is determined and used in connection with these features. For example, only discrete positions (90 degree rotation) may be detected and used to change the entire display screen from landscape to portrait mode.

Additionally, a tilting movement of the computer may be detected and used to launch an application or perform other predefined functions. Typically, a limited amount of information is determined and used in connection with these features. For example, in some cases, only a left-right, right-left, front-back or back-front tilt may be detected.

These known techniques suffer from various drawbacks and limitations.

For example, the limited, discrete detection data (side to side, back to front or 90 degree orientation) limits the usefulness and range of functions that can be performed using movement of the computer device as an input mechanism. Also, to the extent that these prior techniques control movement of a display screen, they typically apply the control to the entire display screen (e.g., screen orientation). But more precise and continuous control of movement relating to individually selected display objects (e.g., individual objects within a screen display) is typically not available. Additionally, these systems also fail to consider use of movement detection to control display objects in a multi display environment.

Other drawbacks exist.

### BRIEF SUMMARY OF THE INVENTION

The systems and methods of the invention relate to providing a computer device, having a display unit, with an accelerometer (or other motion sensor) to detect movement of the computer device (and/or an associated display unit) and generate movement data. An accelerometer driver may receive the generated movement data. The generated movement data may be processed and/or interpreted in order to create one or more control signals. The control signals may be sent to a display driver to control movement of one or more selected display objects on one or more display units. The control signals may control movement of selected display objects on a screen display (or between multiple screen displays) associated with the computer device.

The accelerometer may be included within or on the computer device itself. The accelerometer may be used to detect movement of the computer device, including in some examples, the display unit itself. This may occur, for example, when the computer device and the display unit are connected together (e.g., in a laptop or other device). The accelerometer may generate movement data based on the detected movements. The generated movement data may include movement information relating to tilt, orientation, speed and duration of movement, among other things. The movement information may also include information relating to movement in x-y-z directions (and/or other coordinate systems). The movement data may be output to an accelerometer driver. The accelerometer driver may substantially continuously process and/or interpret the detected movement data (e.g., to mimic a mouse, joystick or other input device) and supply substantially continuous control signals to a CPU of the computer device. The CPU device, through one or more display drivers, may control the movement and/or position of the one or more selected display objects based on the received control signals.

According to one aspect of the invention, one or more display objects, within a single display screen, may be selected (using any suitable selection technique). Based on detected movements and corresponding movement data of the computer device and/or the associated display unit itself, the one or more selected display objects may move relative to one or more other display objects within the single display screen (instead of, for example, rotating an entire display).

According to another aspect of the invention, in a multi-display environment, movement data for the computer device may be used to control movement of one or more selected display objects (e.g., from one display to another).

According to another aspect of the invention, in the context of a 3-dimensional display, movement data for the computer device may be used to control the 3-d display.

### BRIEF DESCRIPTION OF DRAWINGS

FIG. 1 is a high level system architecture diagram, according to one embodiment of the invention.

FIG. 2 is an illustration of a display unit, according to one embodiment of the invention.

FIG. 3a is an illustration of a moveable computer device, according to one embodiment of the invention.

FIG. 3b is an illustration of display object movement with respect to computer device movement, according to one embodiment of the invention.

FIG. 4 is an illustration of moveable content, according to one embodiment of the invention.

FIG. 5a is an illustration of a moveable computer device, according to one embodiment of the invention.

FIG. 5b is an illustration of a multi-screen display system, according to one embodiment of the invention.

### DETAILED DESCRIPTION OF THE INVENTION

The systems and methods of the invention relate to providing a computer device, having a display unit, with an accelerometer (or other motion sensor) to detect movement of the computer device (and/or an associated display unit) and generated movement data based on the detected movement. The movement data may be processed and/or interpreted in order to created one or more control signals. The control signals control movement of selected display objects on a screen display (or between multiple screen displays) associated with the computer device.

The system of the invention may include among other things, a computer device 10, accelerometer 12, accelerometer driver 14, device CPU 16, main memory 18, ROM 20, communication link 22, display drivers (24a, 24b,) I/O devices 26 including display unit(s) (28, 30) and/or other input/output devices 32. These components and corresponding software and/or hardware modules collectively may be used to perform a method with respect to detecting movement of a computer device 10 (and/or associated display unit); generated movement data, processing the movement data to create control signals; and effecting movement of one or more selected display objects on a screen display based on the control signals.

The accelerometer 12 may include hardware and/or software implemented within or on the computer device 10 to detect movement of the computer device 10 and/or the computer device's display unit (e.g., based on user's manipulation of the computer device 10). Other motion sensors may be used including gyroscopes and/or piezoelectric sensors, among other sensors. The accelerometer 12 detects tilt, rotation, position, and/or acceleration (among other movements) of the device. Movement data may be generated based on the detected movements. The movement data may include movement information including, but not limited to, values for acceleration, magnitude of tilt/rotation, and/or information regarding x-y-z direction data (and/or other coordinate systems). The accelerometer driver 14 may be programmed to receive movement data from the accelerometer 12. The accelerometer driver 14 processes and/or interprets the movement data in order to create one or more control signals. The control signals may be used in a variety of ways by the display driver (24a, 24b) to mimic an input device (e.g., mouse, keyboard keys, etc.) to control a display unit (28 and/or 30). Other control functions can be used as well.

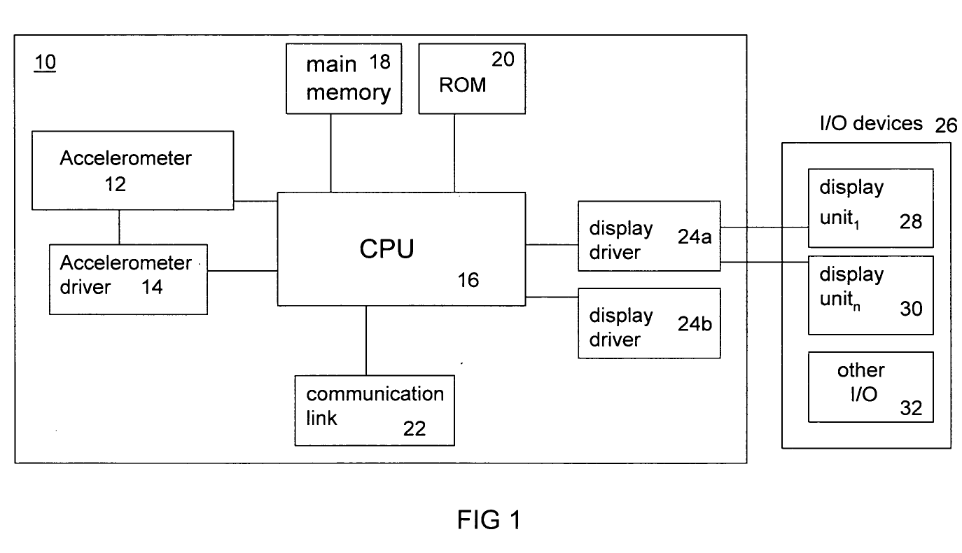

The accelerometer 12 can detect movement(s) of the computer device 10 including movements associated with the computer device's display unit. In one example, when the computer device 10 and the display unit are connected together (e.g., laptop, handheld device, etc.), movement of the computer device 10 is the essentially the same as movement of the display unit. In another example, the computer device 10 may be physically separate from the display unit and therefore movement of one may be done independent of the other. In either example, movement is detected based on where the accelerometer 12 is implemented. FIG. 1 shows the accelerometer 12 implemented on the computer device 10 where the CPU 16 is located. The invention, however, may not necessarily be limited to this implementation.

Movement data may be received at the accelerometer driver 14. The accelerometer driver 14 may substantially continuously process and/or interpret the received movement data to produce substantially continuous control signals. The control signals can provide an input mechanism to various applications and can control movement of selected display objects through one or more display drivers (24a, 24b). The accelerometer driver 14 may substantially continuously communicate the control signals to the device CPU 16. The control signal can be used to effect movement on the screen display via the display driver(s) (24a, 24b).

The CPU 16 is the device's principle processing component and may be linked to, among other things, accelerometer 12, accelerometer driver 14, a main memory 18 (RAM), permanent storage 20 (ROM), communication link 22, display driver(s) 24a, 24b and input/output devices 26 including display units (28, 30) and other I/O devices 32 (e.g., mouse, keyboard, etc.). The CPU 16 can manipulate data from the main memory 18 in order to execute programs stored in permanent storage 20 (ROM). The amount of main memory 18 that the device has can determine how many programs can be executed at one time and how much data can be readily available to a program.

The computer device 10 may be network enabled via a wireless data networking protocol or other networking protocol implemented by the communication link 22. A WLAN (Wireless LAN) is the most common means of wireless networking. It should be understood that a network may also include any one or more of, for instance, an intranet, a PAN (Personal Area Network), a LAN (Local Area Network), a WAN (Wide Area Network), a SAN (Storage Area Network), a MAN (Metropolitan Area Network), or other network.

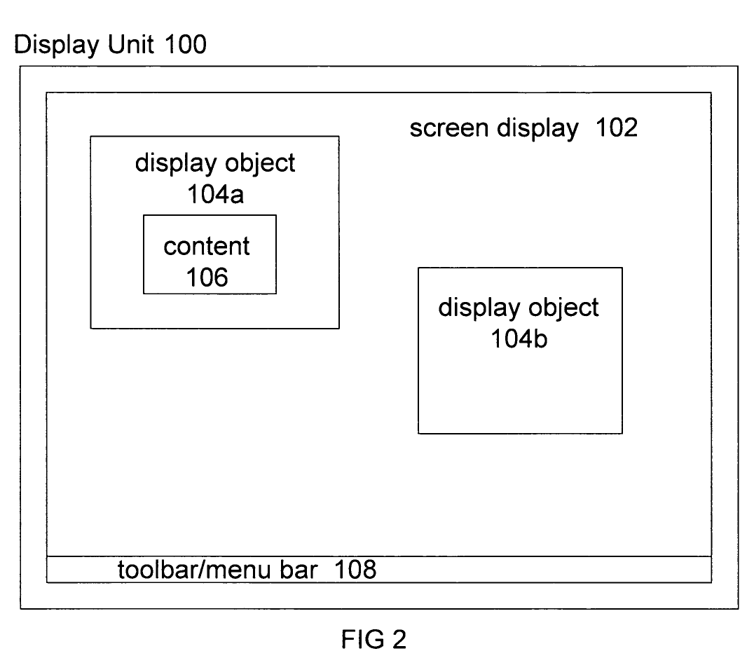

The CPU 16 may be linked to one or more display drivers (24a, 24b). One display driver may communicate with one or more display units. FIG. 2 illustrates a display unit 100. A display unit 100 is the hardware output (and/or input) component used for visual display. The display unit 100 may be incorporated into or associated with the computer device 10. Various types of display units may be used with the system including.LCD screen, CRT monitor, touch screen, rotating/pivoting monitor or LCD, and/or other types. Different display drivers may be used to communicate to different types of display units, respectively. In the case of a touch screen, the display unit itself may be used as an input device to indicate selection of one or more objects on the screen display and to perform other input gestures. In one embodiment the display unit 100 may be physically connected to the computer device 10, CPU 16, and accelerometer 12. In another embodiment the display unit 100 may be physically separate from the computer device 10, CPU 16, and/or accelerometer 12.

As shown in FIG. 2, the display unit 100 may include, among other things, a screen display 102, display objects (104a, 104b), content 106, and/or a toolbar 108. A screen display 102 comprises a visual display presented by the display unit 100. A screen display 102 may include one or more display objects (104a, 104b). A display object (104a, 104b) may be a desktop object, a window (e.g., a web browser window, an application window), an icon, and/or other display object. Display objects may be associated with, among other things, an application, program, and/or file. One or more display objects (104a, 104b) may be displayed and arranged in any manner within the screen display 102. A display object (104a) may include content 106 or other objects (e.g., a file or image) within a display object (104). For example, in an image editing application the application window may include content in the form of a displayed digital photo. Other types of content include text, images, and/or video, among other types.

The screen display 102 may also include a toolbar 108. A toolbar, may be displayed on any part of the screen display and/or hidden from view on the screen display 102 until needed. The toolbar 108 may include a series of selectable graphical buttons, icons, and/or other objects. A user may select display objects (e.g., a desktop object, an application, web browser functions and/or other objects) using the tool bar. The toolbar 108 can be used to, among other things, iconize an application, minimize a running application window, maximize an application window, open an application, and/or close an application window. Other actions may be included.

The accelerometer 12 in combination with the accelerometer driver 14 can provide control signals that may be used to control movement of user selected display objects 104 and/or content 106 on the screen display 102. The control signals may be used in various ways, including to move a selected display object 104 within a single screen display 102; to move content within a display object 104; and/or to move a selected display object from one display unit associated with the computer device 10 to another display unit associated with the computer device 10, among others.

A user may select one or more display objects 104 on a screen display 102. The selected display objects 104 may be associated with control signals representing movement(s) of the computer device 10 and/or the associated display unit 100. Display object 104 may be selected by touch screen, mouse cursor, light pen, keyboard, and/or other selection mechanisms (other I/O 32). In one embodiment, an application and/or its associated display object 104 may be configured to be automatically associated with control signals received from the display driver (24a, 24b) when such application is launched. Once a display object 104 is selected and/or associated with detected movements, the display object 104 can be moved, positioned and/or manipulated on the screen display 102 by the detected device movements and their corresponding control signals.

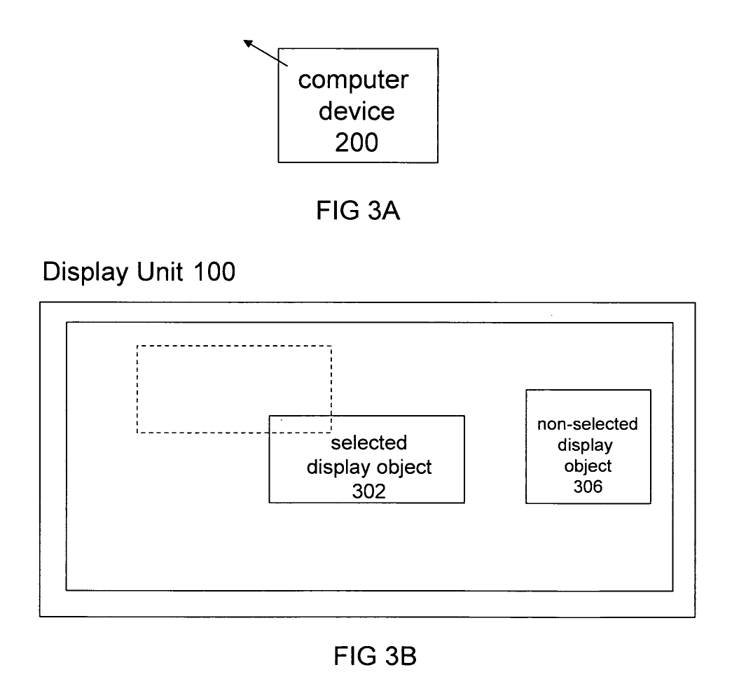

FIG. 3a illustrates a computer device 200. The arrow represents the computer device's direction of tilt as controlled by a user. FIG. 3b illustrates the corresponding movement of a selected display object as a result of the directional tilt shown in FIG. 3a. The selected display object 302 may move in the same direction as the detected tilt and/or rotation of the computer device's display unit. As shown in FIG. 3b, the selected display object 302 may move (e.g., slide across screen) on the screen display 102 towards the upper left hand corner in response to one or more control signals created from movement data based on the computer device being tilted (or moved) towards the left. In the figure, the dashed box represents the placement of the selected display object after the control signal is sent to the display driver. The selected display object 302 may be moved in various orientations, angles and/or directions corresponding to the detected tilt (and/or movement) of the computer device and/or display unit. The selected display object 302 may also be rotated in various increments to match repetitive motion of the computer device and/or display unit.

The selected display object 302 may be moved on the screen relative to the other display object(s) on the screen display (non-selected display object 306).

For example, the selected display object 302 may “float” over another non-selected display object 306 in the same direction of the computer device tilt. In another example, the selected display object 302 may rotate without rotating the entire screen display 102. This allows one or more selected display objects 302 to move independently of non-selected display objects 306 and/or the screen display 102 as a whole. However, if desired, more than one object or an entire screen display can be moved in accordance to the one or more control signals.

The range of movement of the display object 306 can be contained within the boundaries of the display unit's screen display 102 or within multiple screen displays (described in detail below). The control signal may control the on screen speed and direction of the selected display object's 302 movements to correspond to the magnitude of tilt/rotation, duration of tilt, and/or other movement data generated by the accelerometer 12. Alternatively or in addition, the on screen movement speed may be kept at a constant speed. The control signals may also be used in a multi-screen display wherein a selected object 302 may be moved to the edge and/or transitioned to an adjacent screen display after a predetermined duration of tilt (and/or other movement).

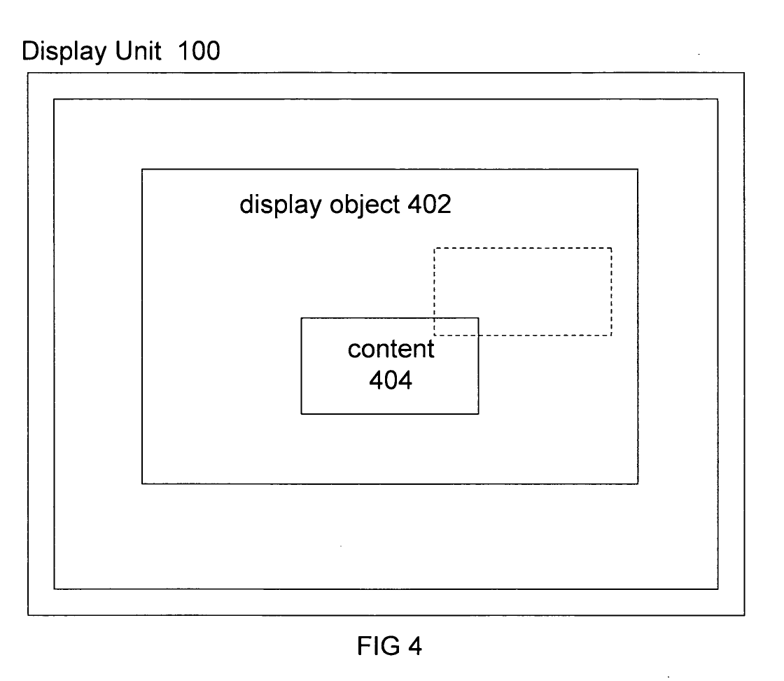

The accelerometer 12 may also control selected content 404 within a display object 402. FIG. 4 illustrates content 404 within a display object 402. In FIG. 4 the dashed box may represent the placement of the selected display object after movement (e.g., tilt) of the computer device 200. The selected content may move within a display object 402 (e.g., window) in various directions corresponding to the one or more control signals created from movement data based on the computer device movement. The content 404 within the display object 402 may be selected in a known manner including by use of a mouse, touch screen, and/or light pen, among others (other I/O 32). The selected content 404 may be rotated, based on movement of the device (e.g., clockwise/counter clockwise rotation), relative to the remainder of the display object 402 with which it is associated. The content 404 of the display object 402 may move independently of the display object 402, itself. For example, within an imaging application, the control signal can rotate a picture from landscape to portrait mode within the application but not rotate the application itself (e.g., including toolbars or other parts of the application).

In another example, the content may be a picture displayed in portrait mode. The device may be rotated in a clockwise direction to effect the rotation of the picture by 90 degrees to the right. Other content, such as selected text images and/or video may also be rotated or moved relative to one or more display objects 402 (e.g. applications, windows, desktops, etc.).

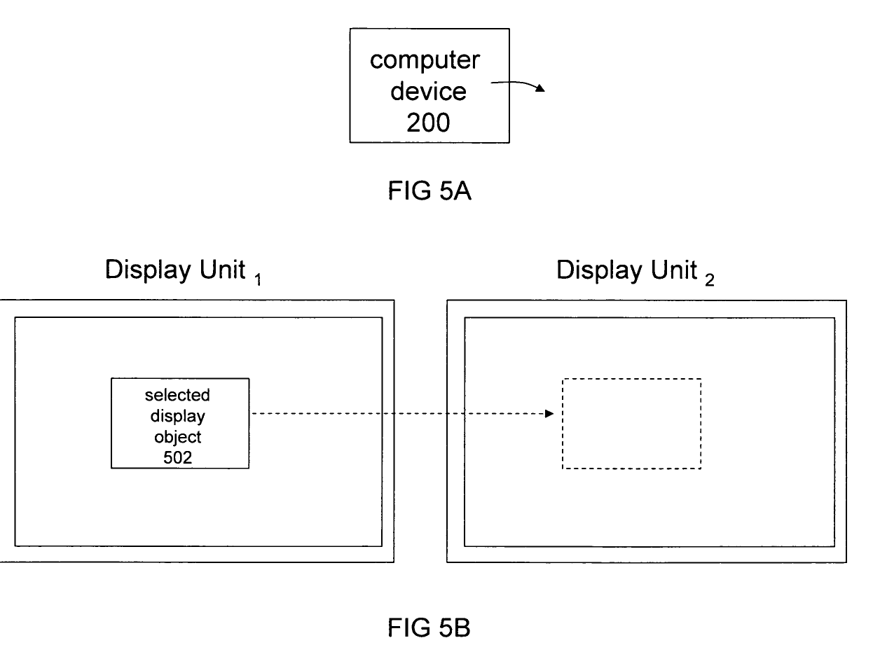

In connection with multiple screen displays, one or more control signals based on movement data can be used as input to move a selected display object 502 (or content) within a screen display or from one screen display to another. FIG. 5a illustrates a computer device 200. The arrow represents the computer device's direction of tilt or movement as controlled by a user. FIG. 5b illustrates the corresponding movement of a selected display object 502 as a result of the directional tilt in FIG. 5a. In particular, FIG. 5b illustrates a multi-screen display demonstrating that a selected display object 502 may be moved from one screen display presented on display unit₁ to another screen display presented on display unit₂. A computer device 10 may have multiple screen displays associated with it. This can include multiple desktops on a single display unit or more than one display unit. In one example, a portable laptop with a built-in display may be connected to an additional external display unit. Each display unit may present a respective screen display.

An accelerometer 12 on the single computer device (having a multi-desktop or more than one display unit) detects movement of the computer device and/or display unit. Movement data generated from the detected movement(s) creates one or more control signals that effect movement of one or more selected display objects 502. In a multi-screen environment, selected display object(s) may move within a single screen display or move from a first screen display of a first display unit to a second screen display (on a second display unit or on another desktop screen display on the first display unit). Multiple display units (more than two) may be arranged for a computer device. Control signals may control movement of selected display objects between adjacent screen displays (screens that share a perimeter on the right, left, top and/or bottom) or any other displays.

Movement of the selected display object 302 from one screen display (represented on display unit₁) to another screen display (represented on display unit₂) may be based on various factors. Movement data, including, but not limited to, the duration of tilt (or other movement), number of repeated movements, and/or magnitude of movement may be used to determine whether a control signal should transition a selected display object 502 from the originating screen display to another screen display. In order to move the selected display object 502 on to another screen display, the movement data may reach and/or exceed a predetermined threshold in order for the control signal to instruct a transition to take effect. The threshold may be a duration in seconds (or other time unit), a number of repeated movements, a predetermined angle of displacement, a speed of movement, and or other thresholds. The predetermined threshold may be preconfigured and later reconfigured for the computer device. Once a threshold is reached and/or exceeded, the selected display object may transition to the adjacent screen in the direction of the detected movement.

The computer device may be a portable computer, PDA (personal digital assistant), web-enabled mobile phone, WAP device, web-to-voice device, handheld computer, cell phone, PDA, laptop, digital music player, or other computing device.

The foregoing presentation of the described embodiments is provided to enable any person skilled in the art to make or use the invention. Various modifications to these embodiments are possible, and the generic principles presented herein may be applied to other embodiments as well. For example, the invention may be implemented in part or in whole as a hard-wired circuit, as a circuit configuration fabricated into an application-specific integrated circuit, as a firmware program loaded into non-volatile storage or a software program loaded from or into a data storage medium as machine-readable code, such code being instructions executable by an array of logic elements such as a microprocessor or other digital signal processing unit, or may include other implementations.

Embodiments of the invention include a computer program containing one or more sequences of machine-readable instructions describing a method as disclosed above, or a data storage medium (e.g. semiconductor memory, magnetic or optical disk) having such a computer program stored therein. The invention is not intended to be limited to the embodiments provided above, but rather is to be accorded the widest scope consistent with the principles and novel features disclosed in any fashion herein.

What is claimed is:

1. A computer implemented method for user with a computer device having an associated display unit, the computer device including an accelerometer for detecting movement of the computer device, the method comprising the steps of:
displaying one or more display objects on a screen of the display unit;
detecting, via the accelerometer, movement of the computer device;
generating movement data based on the detected movement of the computer device;
receiving a selection of one or more display objects to be associated with the movement data;
creating one or more control signals based on the generated movement data; and
controlling the position of the one or more selected display objects on the screen in accordance with the one or more control signals.

2. The method of claim 1, wherein the step of generating further comprises processing the detected movements to determine a magnitude of movement, duration of movement, device position, or a number of repeated movements to include in the movement data.

3. The method of claim 2, wherein the step of processing further comprises determining whether the magnitude of movement, the duration of movement, or the number of repeat movements reaches or exceeds a predetermined threshold.

4. The method of claim 1, wherein the step of controlling further comprises the control signal for controlling movement of one or more selected display objects from the screen of the display unit to a second screen associated with a second display unit.

5. The method of claim 1, wherein the display unit comprises a touch screen device and the step of selecting is based on input received from the touch screen device.

6. A computer system including a computer device for controlling movement of one or more display objects based on movements of the computer device, the system comprising:
a computer device;
a display unit associated with the computer device for displaying one or more display objects on a screen of the display unit;
an accelerometer for detecting movement of the computer device;
a generating means for generating movement data based on the detected movement of the computer device;
a selection receiving mechanism for receiving selection of one or more display objects to be associated with the movement data;
an accelerometer driver for creating one or more control signals based on the generated movement data;
a display driver for controlling the position of the one or more selected display objects based on the one or more control signals.

7. The system of claim 6, wherein the generating means further comprises means for processing the detected movements to determine a magnitude of movement, duration of movement, device position, or number of repeated movements to include in the movement data.

8. The system of claim 7, wherein the processing means further comprises determining means for determining whether the magnitude of movement, the duration of movement, or the number of repeat movements reaches or exceeds a predetermined threshold.

9. The system of claim 6, further comprises a second display unit for displaying a second screen and the display driver is further operable to control movement of the one or more user selected display objects from the screen of the display unit to the second screen based on the one or more control signals.

10. The system of claim 6, wherein the display unit comprises a touch screen device and the selection mechanism is a touch screen device.

11. A computer implemented method for user with a computer device having an associated display unit, the computer device including an accelerometer for detecting movement of the computer device, the method comprising the steps of:
displaying one or more content objects within a display object on a screen of the display unit;
detecting, via the accelerometer, movement of the computer device;
generating movement data based on the detected movement of the computer device;
receiving a selection of one or more content objects within the display object to be associated with the movement data;
creating one or more control signals based on the generated movement data; and
controlling the position of the one or more selected content objects within the display object on the screen in accordance with the one or more control signals.

12. The method of claim 11, wherein the step of generating further comprises processing the detected movements to determine a magnitude of movement, duration of movement, device position, or a number of repeated movements to include in the movement data.

13. The method of claim 12, wherein the step of processing further comprises determining whether the magnitude of movement, the duration of movement, or the number of repeat movements reaches or exceeds a predetermined threshold.

14. The method of claim 11, wherein the display unit comprises a touch screen device and the step of selecting is based on input received from the touch screen device.

15. A computer system including a computer device for controlling movement of one or more display objects based on movements of the computer device, the system comprising:
a computer device;
a display unit associated with the computer device for displaying one or more content objects within a display object on a screen of the display unit;
an accelerometer detecting movement of the computer device;
a generating means for generating movement data based on the detected movement of the computer device;
a selection receiving mechanism for receiving selection of one or more content objects within the display object to be associated with the movement data; and
an accelerometer driver for creating one or more control signals based on the generated movement data;
a display driver for controlling the position of the one or more selected content objects within the display object on the screen in accordance with the one or more control signals.

16. The system of claim 15, wherein the generating means further comprises means for processing the detected movements to determine a magnitude of movement, duration of movement, device position, or number of repeated movements to include in the movement data.

17. The system of claim 16, wherein the processing means further comprises determining means for determining whether the magnitude of movement, the duration of movement, or the number of repeat movements reaches or exceeds a predetermined threshold.

18. The system of claim 15, wherein the display unit comprises a touch screen device and the selection mechanism is a touch screen device.
